(19) United States
(12) Patent Application Publication
(10) Pub. No.: US 2024/0316874 A1
(43) Pub. Date: Sep. 26, 2024

(54) SYSTEMS FOR ULTRASONIC CONSOLIDATION OF MATERIALS

(71) Applicant: Agile Ultrasonics Corp., Hilliard, OH (US)

(72) Inventors: Matthew A. Short, Hilliard, OH (US); James Stratton, Hilliard, OH (US)

(21) Appl. No.: 18/613,452

(22) Filed: Mar. 22, 2024

Related U.S. Application Data
(60) Provisional application No. 63/454,479, filed on Mar. 24, 2023.

(51) Int. Cl. B29C 65/08; B29C 70/08; B29C 70/42; B29C 70/54

(52) U.S. Cl. CPC B29C 65/08; B29C 70/081; B29C 70/42; B29C 70/54

(57) ABSTRACT

A system for ultrasonic consolidation of fiber reinforced thermoplastics, comprising a first component that is either an inner non-resonant mandrel or an inner sonotrode; a second component that is either an outer non-resonant mandrel or an outer sonotrode, wherein the first and second components are configured to receive fiber reinforced thermoplastic materials therebetween, wherein the inner sonotrode and the outer sonotrode are both configured to direct ultrasonic energy into the fiber reinforced thermoplastic materials, wherein the outer sonotrode produces radial displacement against the inner non-resonant mandrel, or wherein the inner sonotrode produces radial displacement against the outer non-resonant mandrel, or wherein the inner sonotrode produces radial displacement against the outer sonotrode, or wherein the outer sonotrode produces radial displacement against the inner sonotrode, and wherein the radial displacement generates compressive stress within the fiber reinforced thermoplastic materials that produces heat and generates a weld therebetween.

### CROSS-REFERENCE TO RELATED APPLICATIONS

This patent application claims the benefit of U.S. Provisional Patent Application Ser. No. 63/454,479 filed on Mar. 24, 2023, and entitled “Advanced Systems and Devices for Ultrasonic Consolidation of Materials” the disclosure of which is hereby incorporated by reference herein in its entirety and made part of the present U.S. utility patent application for all purposes.

### BACKGROUND

The disclosed technology relates in general to manufacturing and fabricating systems, devices, and methods, and more specifically to systems, devices, and methods for ultrasonic consolidation of strength-increasing reinforcing materials such as, for example, materials containing carbon fibers or glass fibers.

The use of ultrasonic welding processes to weld multiple layers of fiber reinforced polymers (FRP) into consolidated structures has proven largely unsuccessful without the use of energy directors or a sacrificial melt layer, or when the anvil component of an ultrasonic welding system includes a rigid surface against which layers of FRP have been placed. Known welding practices typically fixture thermoplastic or thermoplastic composites against a rigid anvil. However, if these welding practices are used with FRP tapes, braids, or pre-consolidated plates, welds cannot usually be achieved without employing the use of traditional energy directors or secondary materials that enhance the welding process. If welds are indeed achieved, the welds are often of an unsatisfactory nature. Accordingly, ultrasonic welding systems that can effectively consolidate FRP tapes into solid structures for use in a variety of applications, including automotive, acronautic, and military applications are of interest. Additionally, certain more recent state of the art technologies include innovative ultrasonic welding processes, support materials, and tooling that significantly advance manufacturing that involves fiber reinforced thermoplastics. While many of these technologies are directed toward applications in the aerospace industry, new potential applications in the consumer/industrial product sectors have emerged, based at least in part on these innovative ultrasonic welding processes, support materials, and tooling. Therefore, additional innovative technologies for deploying specialized ultrasonic tooling for manufacturing a wide variety of structural components from fiber reinforced thermoplastics are also of interest.

### SUMMARY

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”. Additionally, the term “rigid” as used herein refers to a system component that is non-resonant in nature. The terms “rigid” and “non-resonant” are used interchangeably herein.

One embodiment of the disclosed technology provides a first system for ultrasonic consolidation of fiber reinforced thermoplastics, comprising a first component that is either an inner rigid mandrel or an inner sonotrode; and a second component that is either an outer rigid mandrel or an outer sonotrode, wherein the first and second components are configured to receive fiber reinforced thermoplastic materials therebetween, wherein the inner sonotrode and the outer sonotrode are both configured to direct ultrasonic energy into the fiber reinforced thermoplastic materials, wherein the outer sonotrode produces radial displacement against the inner rigid mandrel, or wherein the inner sonotrode produces radial displacement against the outer rigid mandrel, or wherein the inner sonotrode produces radial displacement against the outer sonotrode, or wherein the outer sonotrode produces radial displacement against the inner sonotrode, and wherein the radial displacement generates compressive stress within the fiber reinforced thermoplastic materials that produces heat and generates a weld between the materials.

In certain implementations, the first component is a rigid inner mandrel, the second component is an outer sonotrode, and the outer sonotrode is either a radial sonotrode that surrounds the rigid inner mandrel or a longitudinal sonotrode that surrounds the rigid inner mandrel and that utilizes the Poisson Effect to drive radial contractions, being located at the nodal position or quarter wavelength. In other implementations, the first component is an inner sonotrode, the second component is a rigid outer mandrel, and the rigid outer mandrel surrounds the inner sonotrode. In other implementations, the first component is an inner sonotrode, the second component is an outer sonotrode, and wherein the outer sonotrode surrounds the inner sonotrode. In other implementations, the first component is an inner sonotrode, the second component is a rigid outer mandrel, the rigid outer mandrel surrounds the inner sonotrode, and a compliant viscoelastic support material is positioned between the fiber reinforced thermoplastic material and the rigid outer mandrel to form a flexible inner mandrel. In other implementations, the second component is articulated against the first component in combination with an in-feed and out-feed articulating motion of the fiber reinforced thermoplastic materials for creating complex three-dimensional shapes from the fiber reinforced thermoplastic materials. In certain implementations, the fiber reinforced thermoplastic materials are configured as either tape or braided tape.

Another embodiment of the disclosed technology provides a second system for ultrasonic consolidation of fiber reinforced thermoplastics, comprising a first component that is either an inner rigid mandrel or an inner half-wavelength sonotrode; and a second component that is either an outer rigid mandrel or an outer half-wavelength sonotrode, wherein the first and second components are configured to receive fiber reinforced thermoplastic materials therebetween, wherein the inner half-wavelength sonotrode and the outer half-wavelength sonotrode are both configured to direct ultrasonic energy into the fiber reinforced thermoplastic materials, wherein the outer half-wavelength sonotrode produces radial displacement against the inner rigid mandrel, or wherein the inner half-wavelength sonotrode produces radial displacement against the outer rigid mandrel, or wherein the inner half-wavelength sonotrode produces radial displacement against the outer half-wavelength sonotrode, or wherein the outer half-wavelength sonotrode produces radial displacement against the inner half-wavelength sonotrode, and wherein the radial displacement generates compressive stress within the fiber reinforced thermoplastic materials that produces heat and generates a weld between the materials.

In certain implementations, the first component is a rigid inner mandrel, the second component is an outer half-wavelength sonotrode, and the outer half-wavelength sonotrode is either a radial half-wavelength sonotrode that surrounds the rigid inner mandrel or a longitudinal half-wavelength sonotrode that surrounds the rigid inner mandrel and that utilizes the Poisson Effect to drive radial contractions, being located at the nodal position or quarter wavelength. In other implementations, the first component is an inner half-wavelength sonotrode, the second component is a rigid outer mandrel, and the rigid outer mandrel surrounds the inner half-wavelength sonotrode. In other implementations, the first component is an inner half-wavelength sonotrode, the second component is an outer half-wavelength sonotrode, and wherein the outer half-wavelength sonotrode surrounds the inner half-wavelength sonotrode. In other implementations, the first component is an inner half-wavelength sonotrode, the second component is a rigid outer mandrel, the rigid outer mandrel surrounds the inner half-wavelength sonotrode, and a compliant viscoelastic support material is positioned between the fiber reinforced thermoplastic material and the rigid outer mandrel to form a flexible inner mandrel. In other implementations, the second component is articulated against the first component in combination with an in-feed and out-feed articulating motion of the fiber reinforced thermoplastic materials for creating complex three-dimensional shapes from the fiber reinforced thermoplastic materials. In certain implementations, the fiber reinforced thermoplastic materials are configured as either tape or braided tape.

Still another embodiment of the disclosed technology provides a third system for ultrasonic consolidation of fiber reinforced thermoplastics, comprising a first component, wherein the first component is either an inner non-resonant rigid mandrel or an inner half-wavelength sonotrode; and a second component, wherein the second component is either an outer non-resonant rigid mandrel or an outer half-wavelength sonotrode, wherein the first and second components are configured to receive tape or braided tape fiber reinforced thermoplastic materials therebetween, wherein the inner half-wavelength sonotrode and the outer half-wavelength sonotrode are both configured to direct ultrasonic energy into the fiber reinforced thermoplastic materials, and wherein the outer half-wavelength sonotrode produces radial displacement against the non-resonant rigid inner mandrel, or wherein the inner half-wavelength sonotrode produces radial displacement against the outer non-resonant rigid mandrel, or wherein the inner half-wavelength sonotrode produces radial displacement against the outer half-wavelength sonotrode, or wherein the outer half-wavelength sonotrode produces radial displacement against the inner half-wavelength sonotrode, and wherein the radial displacement generates compressive stress within the fiber reinforced thermoplastic materials that produces heat and generates a weld between the materials.

In certain implementations, the first component is a non-resonant rigid inner mandrel, the second component is an outer half-wavelength sonotrode, and the outer half-wavelength sonotrode is either a radial half-wavelength sonotrode that surrounds the rigid inner mandrel or a longitudinal half-wavelength sonotrode that surrounds the rigid inner mandrel and that utilizes the Poisson Effect to drive radial contractions, being located at the nodal position or quarter wavelength. In other implementations, the first component is an inner half-wavelength sonotrode, the second component is a non-resonant rigid outer mandrel, and the non-resonant rigid outer mandrel surrounds the inner half-wavelength sonotrode. In other implementations, the first component is an inner half-wavelength sonotrode, the second component is an outer half-wavelength sonotrode, and the outer half-wavelength sonotrode surrounds the inner half-wavelength sonotrode. In other implementations, the first component is an inner half-wavelength sonotrode, the second component is a non-resonant rigid outer mandrel, the non-resonant rigid outer mandrel surrounds the inner half-wavelength sonotrode, and a compliant viscoelastic support material is positioned between the fiber reinforced thermoplastic material and the non-resonant rigid outer mandrel to form a flexible inner mandrel. In other implementations, the second component is articulated against the first component in combination with an in-feed and out-feed articulating motion of the fiber reinforced thermoplastic materials for creating complex three-dimensional shapes from the fiber reinforced thermoplastic materials.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed technology and, together with the general description given above and detailed description given below, serve to explain the principles of the disclosed subject matter, and wherein:

FIG. 1A is a front view of a first example implementation of the disclosed technology wherein a rigid mandrel is surrounded by a half-wavelength radial sonotrode;

FIG. 1B is a cross-sectional side view of the implementation of FIG. 1A;

FIG. 2A is a front view of a second example implementation of the disclosed technology wherein a half-wavelength sonotrode is surrounded by a rigid mandrel;

FIG. 2B is a cross-sectional side view of the implementation of FIG. 2A;

FIG. 3 is a cross-sectional view of a third example implementation of the disclosed technology, wherein an inner sonotrode is surrounded by an outer sonotrode, and wherein the inner and outer sonotrodes operate in unison to produce radial vibrations for in situ welding of CFRTP;

FIG. 4A is a front view of a fourth example implementation of the disclosed technology wherein a half-wavelength sonotrode is surrounded by a mandrel, and wherein a layer of compliant viscoelastic compliant layer exhibiting radial displacement has been incorporated into the apparatus;

FIG. 4B is a cross-sectional side view of the implementation of FIG. 4A; and

FIG. 5 depicts an articulating motion of inner/outer mandrel/sonotrodes for producing three dimensional shapes.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed technology. Accordingly, the following implementations are set forth without any loss of generality to, and without imposing limitations upon, the claimed subject matter.

The examples discussed herein are examples only and are provided to assist in the explanation of the apparatuses, devices, systems, and methods described herein. None of the features or components shown in the drawings or discussed below should be taken as required for any specific implementation of any of these the apparatuses, devices, systems, or methods unless specifically designated as such. For ease of reading and clarity, certain components, modules, or methods may be described solely in connection with a specific Figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

With reference to the Figures, two primary material configurations whereby CFRTP is consolidated into various components include: (i) tape; and (ii) braided tape. This disclosed technology applies to material configurations and may be used to form these materials into functional hardware. The disclosed technology, which includes articulating ultrasonic tooling, may be used for in situ manufacturing of carbon fiber reinforced thermoplastics (CFRTP) components having complex geometries. Implementations of the disclosed tooling may be used at a wide range of frequencies (e.g., 10-100 kHz) and power levels (e.g., 50-5,000 W).

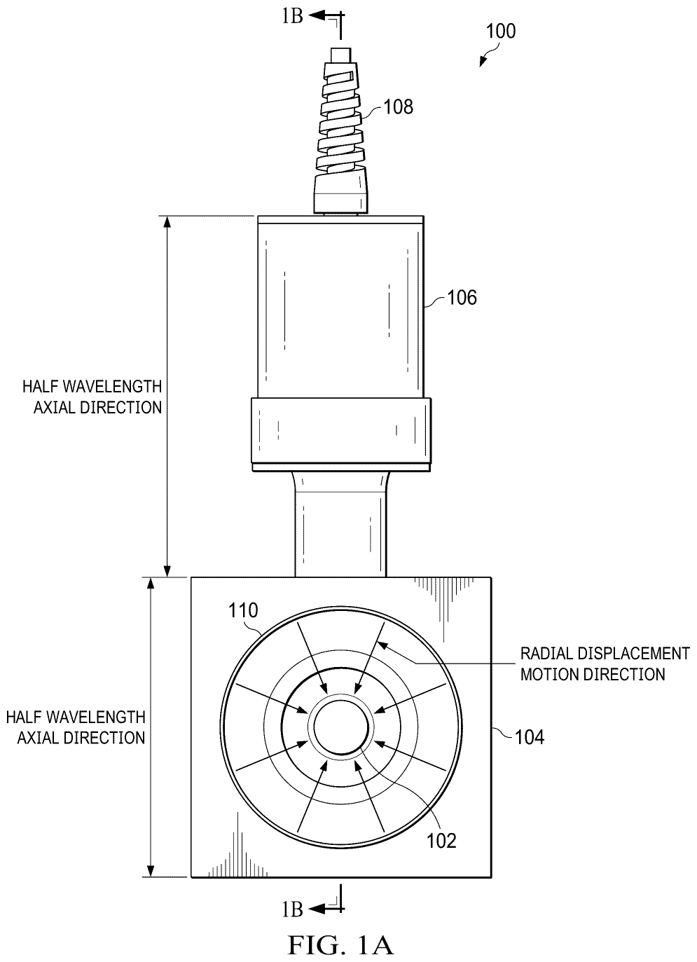

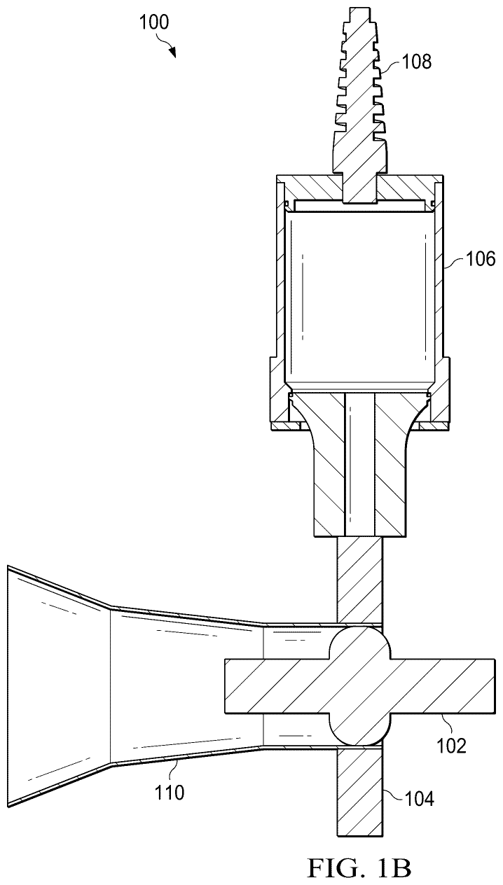

FIG. 1A provides a front view of a first example implementation of the disclosed technology, and FIG. 1B provides a cross-sectional side view of the implementation of FIG. 1A. As depicted in FIGS. 1A and 1B, ultrasonic consolidation system 100 includes inner rigid (non-resonant) mandrel 102, outer half-wavelength square sonotrode 104, ultrasonic transducer 106 with connector 108, and CFRTP tape/braid feed stock 110. System 100 utilizes ultrasonic energy for in situ consolidation of CFRTP parts and rigid support mandrel 102 is surrounded by hollow half-wavelength sonotrode 104. Tape, woven tape, or weaved fibers are properly oriented and fed together over rigid internal support mandrel 102 and hollow radial sonotrode 104 is placed around this assembly of composite materials. The hollow portion of sonotrode 104 is located at the nodal region, or quarter wavelength, of half-wavelength sonotrode 104 for utilizing the Poisson effect, whereby radial vibrations produce a compressive oscillation load against internal support mandrel 102. This compressive stress initiates viscoelastic heating of the thermoplastic resin, thereby facilitating a weld between the composite materials.

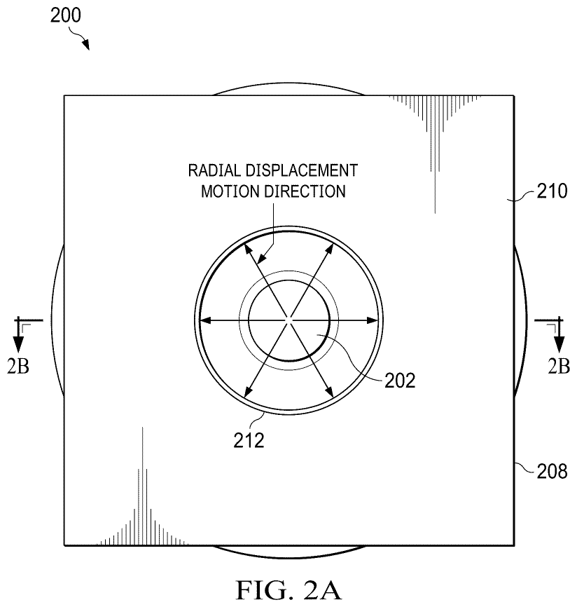

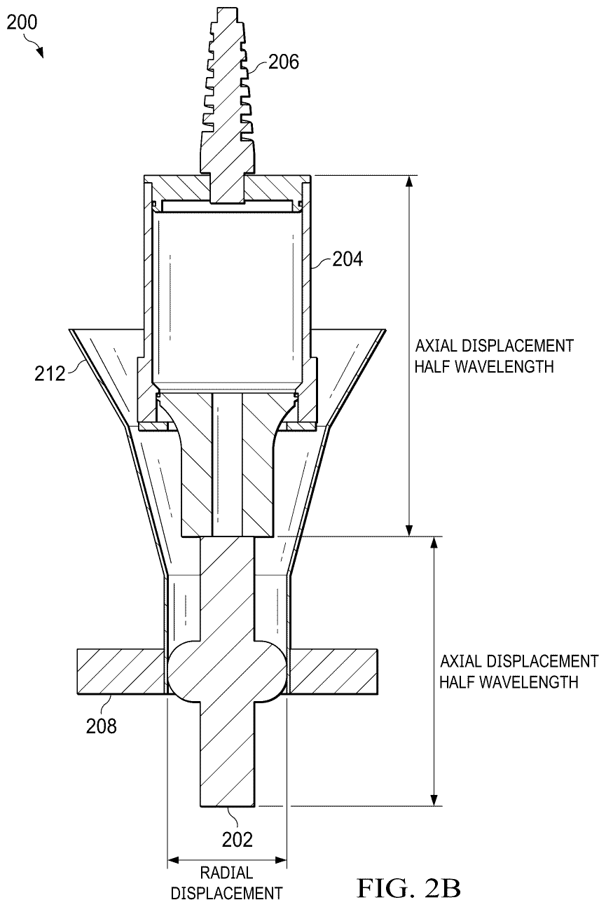

FIG. 2A provides a front view of a second example implementation of the disclosed technology, and FIG. 2B is a cross-sectional side view of the implementation of FIG. 2A. As depicted in FIGS. 2A and 2B, ultrasonic consolidation system 200 includes inner resonant half-wavelength sonotrode 202, ultrasonic transducer 204 having connector 206, outer non-resonant rigid mandrel 208, outfeed face of outer mandrel 210, and CFRTP tape/braid feed stock 212. System 200 utilizes ultrasonic energy for in situ consolidation of CFRTP parts and includes resonant half-wavelength sonotrode 202 surrounded by non-resonant rigid mandrel 208. The critical operating region of half-wavelength sonotrode 202 is located at the nodal region, or quarter wavelength of half-wavelength sonotrode 202. Mandrel 208 surrounds sonotrode 202 and supports CFRTP materials 212 that are fed through the central region of mandrel 208 and over the internal geometry of sonotrode 202. When in resonance, sonotrode 202 produces radial displacement against mandrel 208, thereby generating compressive stress within CFRTP materials 212 that produces heat and generates a weld between the materials.

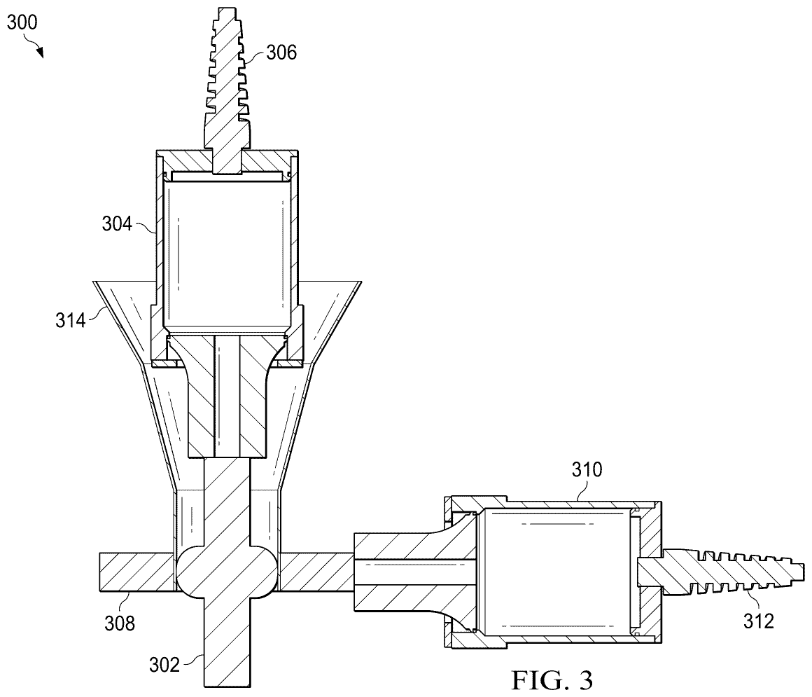

FIG. 3 provides a cross-sectional view of a third example implementation of the disclosed technology. As depicted in FIG. 3, ultrasonic consolidation system 300 includes inner shaping sonotrode/first mandrel 302, first transducer 304 having first connector 306, outer square resonant shaping sonotrode/second mandrel 308, second transducer 310 having second connector 312, and CFRTP tape/braid feed stock 314. As will be appreciated by one of ordinary skill in the art, the Poisson effect is significantly affected by tooling geometry. As the distance from the nodal region increases radially, greater displacement is produced. This effect is relevant regarding the broad use of the disclosed technology for various applications and for the creation of components of varying sizes. Accordingly, a third example implementation of the disclosed technology includes inner and outer mandrels 302, 308 that are actually resonant sonotrodes operating in phase with one another. This configuration increases the total displacement of smaller tools where both sonotrodes are used to generate necessary contact stress. This same configuration can be used for larger tool geometries, thereby taking advantage of the increased displacement for achieving significantly higher processing speeds. As depicted in the Figures, an inner sonotrode 302 is surrounded by an outer sonotrode 308 and the inner and outer sonotrodes operate in unison to produce radial vibrations for in situ welding of CFRTP using high power ultrasound.

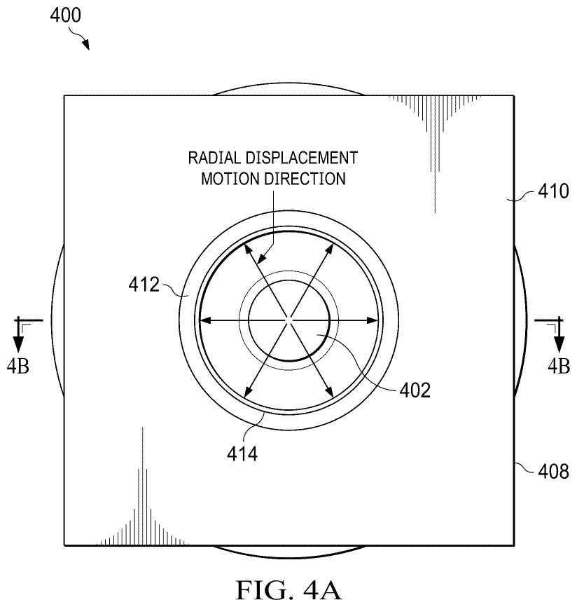

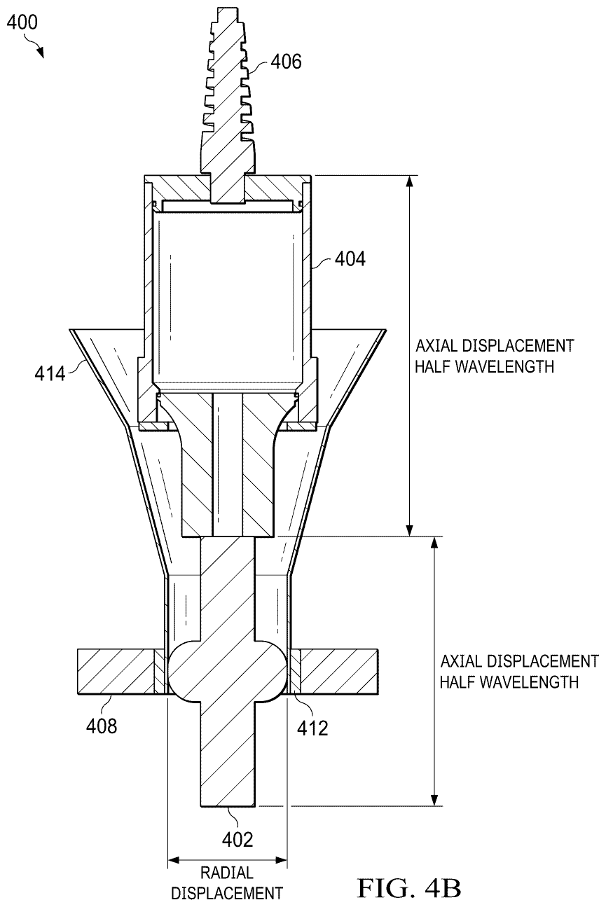

FIG. 4A provides a front view of a fourth example implementation of the disclosed technology and FIG. 4B is a cross-sectional side view of the implementation of FIG. 4A. As depicted in FIG. 3, ultrasonic consolidation system 400 includes inner shaping sonotrode 402, transducer 404 having connector 406, outer square, non-resonant mandrel 408, outfeed face of outer mandrel 410, inner flexible mandrel/compliant viscoelastic support layer 412, and CFRTP feed stock 414. This implementation replaces a rigid mandrel with an elastic mandrel for utilizing viscoelastic heating that occurs within a compliant support material. An elastic mandrel can be constructed from multiple layers of material, from a single material, or from a combination of highly elastic materials and/or rigid substrates that generate viscoelastic heating when excited by ultrasonic vibrations. Heat is conducted into CFRTP feed stock 414 and in combination with the internal heating of the materials themselves, the welding process is thereby enhanced. In various implementations, compliant viscoelastic support layer 412 is located within outer mandrel 408, within an inner mandrel, or both. As depicted in FIG. 4A half-wavelength sonotrode 402 is surrounded by mandrel 408, and compliant viscoelastic support layer 412 has been incorporated into the apparatus.

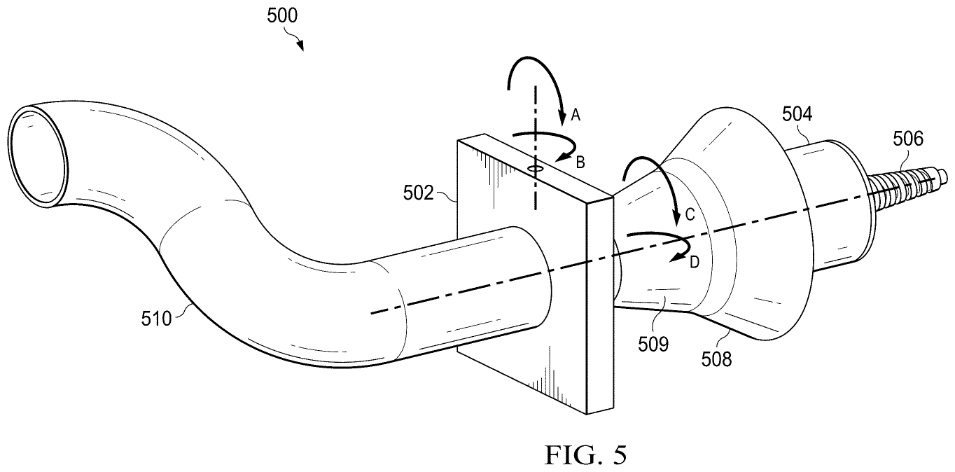

FIG. 5 depicts a fifth example implementation of the disclosed technology wherein an articulating motion of inner/outer mandrel/sonotrodes for producing three-dimensional shapes. As shown in FIG. 5, ultrasonic consolidation system 500 includes square non-resonant mandrel 502, ultrasonic transducer 504 having connector 506, CFRTP tape/braid feed stock 508, and part having complex geometry 510, which is the result of continuous consolidation of shaped geometry by articulating mandrel 502 and a sonotrode (not visible FIG. 5) during manufacturing. This implementation of the disclosed technology includes deploying the disclosed technology in an automated environment for complicated articulation of the welding apparatus. By articulating the outer mandrel 502 against the inner sonotrode (not shown), in conjunction with in-feed and out-feed articulating motion, complex three-dimensional shapes can be produced. This implementation provides highly active nodal tooling articulated in a manner that produces continuous in situ consolidation of CFRTP parts having complex geometry. Articulation of an outer mandrel/sonotrode, an inner mandrel/sonotrode, or both may be used to produce desired geometries. Tape, braided tape, or woven fibers are all fed in a continuous manner.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differ from or contradict this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about”, if or when used throughout this specification describe and account for small fluctuations, such as due to variations in processing. For example, these terms can refer to less than or equal to +5%, such as less than or equal to +2%, such as less than or equal to +1%, such as less than or equal to +0.5%, such as less than or equal to +0.2%, such as less than or equal to +0.1%, such as less than or equal to +0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed technology. Various functions and elements described herein may be partitioned differently from those shown without departing from the scope of the disclosed technology. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the figures, only for facilitating description of the disclosed technology and simplifying the description, rather than indicating or implying that the referred devices or elements must be in a particular orientation or constructed or operated in the particular orientation, and therefore they should not be construed as limiting the disclosed technology. The terms “connected”, “mounted”, “fixed”, etc. should be understood in a broad sense. For example, “connected” may be a fixed connection, a detachable connection, or an integral connection, a direct connection, or an indirect connection through an intermediate medium. For one of ordinary skill in the art, the specific meaning of the above terms in the disclosed technology may be understood according to specific circumstances.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

What is claimed:

1. A system for ultrasonic consolidation of fiber reinforced thermoplastics, comprising:
(a) a first component, wherein the first component is either an inner non-resonant mandrel or an inner sonotrode; and
(b) a second component, wherein the second component is either an outer non-resonant mandrel or an outer sonotrode,
(c) wherein the first and second components are configured to receive fiber reinforced thermoplastic materials therebetween,
(d) wherein the inner sonotrode and the outer sonotrode are both configured to direct ultrasonic energy into the fiber reinforced thermoplastic materials,
(e) wherein the outer sonotrode produces radial displacement against the inner non-resonant mandrel, or wherein the inner sonotrode produces radial displacement against the outer non-resonant mandrel, or wherein the inner sonotrode produces radial displacement against the outer sonotrode, or wherein the outer sonotrode produces radial displacement against the inner sonotrode, and
(f) wherein the radial displacement generates compressive stress within the fiber reinforced thermoplastic materials that produces heat and generates a weld between the materials.

2. The system of claim 1, wherein the first component is a non-resonant inner mandrel, wherein the second component is an outer sonotrode, and wherein the outer sonotrode is either a radial sonotrode that surrounds the inner mandrel or a longitudinal sonotrode that surrounds the inner mandrel and that utilizes the Poisson Effect to drive radial contractions, being located at the nodal position or quarter wavelength.

3. The system of claim 1, wherein the first component is an inner sonotrode, wherein the second component is a non-resonant outer mandrel, and wherein the non-resonant outer mandrel surrounds the inner sonotrode.

4. The system of claim 1, wherein the first component is an inner sonotrode, wherein the second component is an outer sonotrode, and wherein the outer sonotrode surrounds the inner sonotrode.

5. The system of claim 1, wherein the first component is an inner sonotrode, wherein the second component is a non-resonant outer mandrel, wherein the non-resonant outer mandrel surrounds the inner sonotrode, and wherein a compliant viscoelastic support material is positioned between the fiber reinforced thermoplastic material and the non-resonant outer mandrel to form a flexible inner mandrel.

6. The system of claim 1, wherein the second component is articulated against the first component in combination with an in-feed and out-feed articulating motion of the fiber reinforced thermoplastic materials for creating complex three-dimensional shapes from the fiber reinforced thermoplastic materials.

7. The system of claim 1, wherein the fiber reinforced thermoplastic materials are configured as either tape or braided tape.

8. A system for ultrasonic consolidation of fiber reinforced thermoplastics, comprising:
(a) a first component, wherein the first component is either an inner non-resonant mandrel or an inner half-wavelength sonotrode; and
(b) a second component, wherein the second component is either an outer non-resonant mandrel or an outer half-wavelength sonotrode,
(c) wherein the first and second components are configured to receive fiber reinforced thermoplastic materials therebetween,
(d) wherein the inner half-wavelength sonotrode and the outer half-wavelength sonotrode are both configured to direct ultrasonic energy into the fiber reinforced thermoplastic materials,
(e) wherein the outer half-wavelength sonotrode produces radial displacement against the non-resonant inner mandrel, or wherein the inner half-wavelength sonotrode produces radial displacement against the outer non-resonant mandrel, or wherein the inner half-wavelength sonotrode produces radial displacement against the outer half-wavelength sonotrode, or wherein the outer half-wavelength sonotrode produces radial displacement against the inner half-wavelength sonotrode and
(f) wherein the radial displacement generates compressive stress within the fiber reinforced thermoplastic materials that produces heat and generates a weld between the materials.

9. The system of claim 8, wherein the first component is a non-resonant inner mandrel, wherein the second component is an outer half-wavelength sonotrode, and wherein the outer half-wavelength sonotrode is either a radial half-wavelength sonotrode that surrounds the non-resonant inner mandrel or a longitudinal half-wavelength sonotrode that surrounds the non-resonant inner mandrel and that utilizes the Poisson Effect to drive radial contractions, being located at the nodal position or quarter wavelength.

10. The system of claim 8, wherein the first component is an inner half-wavelength sonotrode, wherein the second component is a non-resonant outer mandrel, and wherein the non-resonant outer mandrel surrounds the inner half-wavelength sonotrode.

11. The system of claim 8, wherein the first component is an inner half-wavelength sonotrode, wherein the second component is an outer half-wavelength sonotrode, and wherein the outer half-wavelength sonotrode surrounds the inner half-wavelength sonotrode.

12. The system of claim 8, wherein the first component is an inner half-wavelength sonotrode, wherein the second component is a non-resonant outer mandrel, wherein the non-resonant outer mandrel surrounds the inner half-wavelength sonotrode, and wherein a compliant viscoelastic support material is positioned between the fiber reinforced thermoplastic material and the non-resonant outer mandrel to form a flexible inner mandrel.

13. The system of claim 8, wherein the second component is articulated against the first component in combination with an in-feed and out-feed articulating motion of the fiber reinforced thermoplastic materials for creating complex three-dimensional shapes from the fiber reinforced thermoplastic materials.

14. The system of claim 8, wherein the fiber reinforced thermoplastic materials are configured as either tape or braided tape.

15. A system for ultrasonic consolidation of fiber reinforced thermoplastics, comprising:
(a) a first component, wherein the first component is either an inner non-resonant mandrel or an inner half-wavelength sonotrode; and
(b) a second component, wherein the second component is either an outer non-resonant mandrel or an outer half-wavelength sonotrode,
(c) wherein the first and second components are configured to receive tape or braided tape fiber reinforced thermoplastic materials therebetween,
(d) wherein the inner half-wavelength sonotrode and the outer half-wavelength sonotrode are both configured to direct ultrasonic energy into the fiber reinforced thermoplastic materials, and
(e) wherein the outer half-wavelength sonotrode produces radial displacement against the non-resonant inner mandrel, or wherein the inner half-wavelength sonotrode produces radial displacement against the outer non-resonant mandrel, or wherein the inner half-wavelength sonotrode produces radial displacement against the outer half-wavelength sonotrode, or wherein the outer half-wavelength sonotrode produces radial displacement against the inner half-wavelength sonotrode, and
(f) wherein the radial displacement generates compressive stress within the fiber reinforced thermoplastic materials that produces heat and generates a weld between the materials.

16. The system of claim 15, wherein the first component is a non-resonant inner mandrel, wherein the second component is an outer half-wavelength sonotrode, and wherein the outer half-wavelength sonotrode is either a radial half-wavelength sonotrode that surrounds the non-resonant inner mandrel or a longitudinal half-wavelength sonotrode that surrounds the non-resonant inner mandrel and that utilizes the Poisson Effect to drive radial contractions, being located at the nodal position or quarter wavelength.

17. The system of claim 15, wherein the first component is an inner half-wavelength sonotrode, wherein the second component is a non-resonant outer mandrel, and wherein the non-resonant outer mandrel surrounds the inner half-wavelength sonotrode.

18. The system of claim 15, wherein the first component is an inner half-wavelength sonotrode, wherein the second component is an outer half-wavelength sonotrode, and wherein the outer half-wavelength sonotrode surrounds the inner half-wavelength sonotrode.

19. The system of claim 15, wherein the first component is an inner half-wavelength sonotrode, wherein the second component is a non-resonant outer mandrel, wherein the non-resonant outer mandrel surrounds the inner half-wavelength sonotrode, and wherein a compliant viscoelastic support material is positioned between the fiber reinforced thermoplastic material and the non-resonant outer mandrel to form a flexible inner mandrel.

20. The system of claim 15, wherein the second component is articulated against the first component in combination with an in-feed and out-feed articulating motion of the fiber reinforced thermoplastic materials for creating complex three-dimensional shapes from the fiber reinforced thermoplastic materials.
